(19) United States
(12) Patent Application Publication
(10) Pub. No.: US 2002/0131716 A1
(43) Pub. Date: Sep. 19, 2002

(54) Optical subassembly and method of alignment thereof

(76) Inventor: Glenn C. Van Orden, Flemington, NJ (US)

Correspondence Address: JONES VOLENTINE, P.L.L.C., SUITE 150, 12200 SUNRISE VALLEY DRIVE, RESTON, VA, 20191, US

(21) Appl. No.: 09/907,497

(22) Filed: Jul. 16, 2001

Related U.S. Application Data
(60) Provisional application No. 60/276,209, filed on Mar. 16, 2001.

(51) Int. Cl. G02B 6/26; G02B 6/42

(52) U.S. Cl. 385/52

(57) ABSTRACT

According to an exemplary embodiment of the present invention, a method of fabricating an optical device includes moving a first optical element in a first plane, and moving a second optical element in a second plane, which is orthogonal to the first plane; and aligning the first optical element to the second optical element.

According to another illustrative embodiment of the present invention, an optical device includes a first optical element disposed over a structure, and a second optical element, wherein the first optical element and the second optical element are aligned with a tolerance in the range of approximately ±0.5 μm to approximately ±5 μm.

### CROSS-REFERENCE TO RELATED APPLICATIONS

The present application is related to and claims priority from U.S. Provisional Patent Application No. 60/276,209 filed Mar. 16, 2001. The disclosure of this provisional application is specifically incorporated by reference.

### FIELD OF THE INVENTION

The present invention relates generally to an optical subassembly and its method of alignment, and particularly to a technique for effecting alignment in orthoganal mounting planes.

### BACKGROUND OF THE INVENTION

The increasing demand for high-speed voice and data communications has led to an increased reliance on optical communications, especially optical fiber communications. The use of optical signals as a vehicle to carry channeled information at high-speeds is preferred in many instances to carrying channeled information at other electromagnetic wavelengths/frequencies in media such as microwave transmission lines, coaxial cable lines and twisted-pair transmission lines. Advantages of optical media include higher channel capacities (bandwidth) a greater immunity to electromagnetic interference, and a lower propagation loss. In fact, it is common for high-speed optical signals to have signal rates in the range of approximately several megabits per second (Mbits/sec) to approximately several tens of gigabits per second (Gbits/sec), and greater.

However, while optical components are particularly useful for achieving high signal rates, mass production of optical subassemblies at acceptable yield levels by conventional techniques has proven to be problematic. This is primarily due to misalignment of various elements. One place where optical coupling is usefully precise is at the coupling between an active device of the subassembly and an optical waveguide of the optical communication system. One way to carry out alignment is by actively aligning the various elements. While active alignment offers acceptable precision, it is often very labor intensive, and accordingly can result in prohibitive costs as well as relatively low production output levels. As such, the optical communications industry has been driven to develop techniques for high precision alignment in mass production. One such technique for effecting alignment of optical components precisely and in mass production is passive alignment.

While the alignment of optical devices in a relatively passive manner has met with some success, certain problems associated with alignment of an active device in an optical subassembly to other optical elements the subassembly remain. One such problem relates to the cumulative nature of alignment tolerances. To this end, as various elements are co-located on a substrate, the individual tolerances of the components are additive. This limitation of the overall tolerance to the sum of the tolerances of the parts can result in the tolerance's being outside acceptable ranges required for efficient performance. While the additive affect of alignment tolerances may occur in all directions of alignment, they are particularly problematic in height registration. This is often referred to as “stack-up” error, and its mitigation by conventional techniques has met with mixed success.

What is needed, therefore, is a technique for aligning the various elements of an optical subassembly in a manner which overcomes the shortcomings of the prior art, as recited above.

### SUMMARY OF THE INVENTION

According to an exemplary embodiment of the present invention, a method of fabricating an optical device includes moving a first optical element in a first plane, and moving a second optical element in a second plane, which is orthogonal to the first plane; and aligning the first optical element to the second optical element.

According to another illustrative embodiment of the present invention, an optical device includes a first optical element disposed over a structure, and a second optical element, wherein the first optical element and the second optical element are aligned with a tolerance in the range of approximately ±0.5 μm to approximately ±5 μm.

Advantageously, in accordance with the illustrative embodiments of the present invention, the optical alignment of the first optical element to the second optical element substantially reduces the additive effect of alignment tolerance, and particularly problems associated with “stack-up” tolerances.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIG. 1 is a perspective view of an optical device according to an illustrative embodiment of the present invention.

FIG. 2 is a perspective view of an optical device according to an illustrative embodiment of the present invention.

FIG. 3 is a perspective view of an optical device according to an illustrative embodiment of the present invention.

FIG. 4(a) is a perspective view of an optical device according to an illustrative embodiment of the present invention.

FIG. 4(b) is a top view of the illustrative embodiment shown in FIG. 4(a).

FIG. 4(c) is a side view of the illustrative embodiment shown in FIG. 4(a).

### DEFINED TERMS

For the purposes of the present disclosure, the term “on” may mean directly on top of a layer or other structure; alternatively, the term “on” may mean “over” with one or more intervening layers, gaps, or structures therebetween.

### DETAILED DESCRIPTION

In the following detailed description, for purposes of explanation and not limitation, exemplary embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

Briefly, the present relates to an optical device and its method of manufacture which improves the alignment of various elements by substantially reducing the additive effect of tolerances of elements. The alignment method according to the exemplary embodiments of the present invention may be manual, automated or combination thereof. The automated techniques may include robotic techniques tailored for precise movement needed for optical alignment.

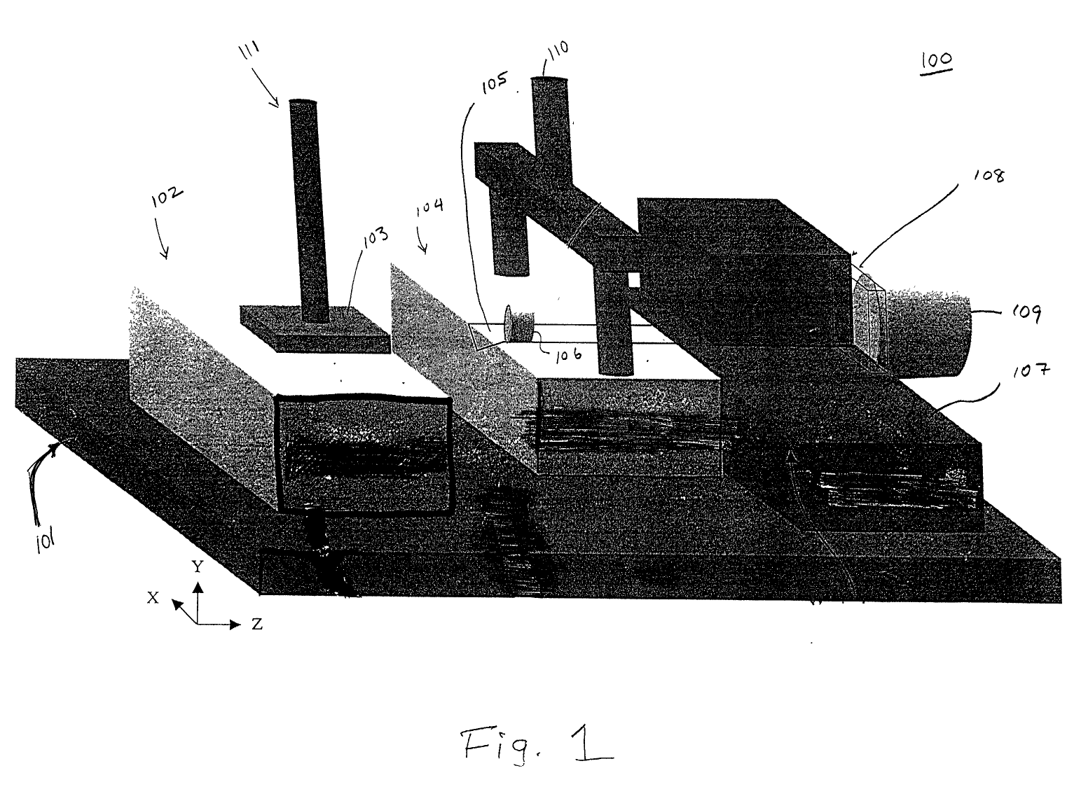

FIG. 1 shows an optical device 100 according to an illustrative embodiment of the present invention. The optical device 100 is illustratively an optical subassembly which may be used in an optical transmitter, an optical receiver, or an optical transponder. A first structure 104 includes a registration feature 105, which has a first optical element 106 disposed therein. A second structure 102, which includes a second optical element 103, is disposed on a substrate 101. First structure 104 may be disposed on the substrate 101. Alternatively, first structure 104 may be over the substrate 101 with a gap therebetween. In the illustrative embodiment shown in FIG. 1, the second optical element 103 is an active optical device, for example an optical emitter or an optical detector. Moreover, the registration feature 105 is illustratively a v-groove or pit which is used for suitable placement of the first optical element 106, which is illustratively a passive optical element.

Illustratively, second optical element 103 is any light-emitting device (such as a laser) or any light-detecting device (such as a PIN detector). The first optical element 106 may be any passive optical element, such as a ball lens, diffractive optical element (e.g. a holographic lens), aspherical lens, isolator, or fiber. It is of interest to note that alignment fiducials (not shown) may be used in conjunction with machine vision equipment to set the various elements “close” to an optimal location. Then the second optical element 103 would be powered-up and an active alignment technique carried out (an illustrative active alignment technique is described herein). Second optical element 103 usually has a metallization pattern that is used as a registration feature (not shown). Registration feature 105 may be used in the alignment of first optical element 106. The second optical element 103 is optically coupled to the first optical element 106, which is coupled to an optical waveguide (not shown) such as an optical fiber (also not shown). The optical waveguide (such as an optical fiber) may be coupled to the optical device 100 by way of a connector 109.

A method for aligning the first optical element 106 to the second optical element 103; and for aligning the first optical element 106 to the optical waveguide (not shown) may be carried out according to the presently described exemplary embodiment. The first structure 104 may be held against the bulkhead 107 during manufacturing by a first active alignment tool 110. The first active alignment tool 110 shown is illustrative, and clearly other tools may be used to hold and translate the second structure 104. Moreover, active alignment may be effected manually and/or by automated techniques using the first alignment tool 110. It is noted that the automated techniques used to effect the active alignment are those well known to one have ordinary skill in the art to which the present invention relates.

The first optical structure 104 may be held against the bulkhead 107 by the first active alignment tool 110 at a vertical height (+y-direction in the Cartesian coordinate system shown in FIG. 1) great enough so that the first optical element 106 may be actively aligned. To this end, a relatively course alignment of the first optical element 106 and the second optical element 103 may be effected in the x-y plane through suitable motion of the first structure 104 via manipulation with the first active alignment tool 110. It is noted that the registration of the second optical element 103 and the first optical element 106 in the z-direction is illustratively achieved in this first step primarily through the movement of the second structure 102 via second active alignment tool 111. As before, the movement may be effected manually and/or by automated techniques as referenced above. Finally, electrical connections needed to effect active alignment may be made to the second optical element 103 (e.g. laser or detector). The second active alignment tool 111 may be used as one ‘probe’ in the electrical path. Another probe (not shown) may be applied to the second structure 102, which completes the required electrical path.

After the initial active alignment in the x-y plane described above, the second structure 102 may be bonded to the substrate 101. The foregoing may be the only active alignment step carried out if it is determined that any resultant inaccuracy caused by the following motion of elements and bonds is acceptable. The bonding of the second optical element 103 to second structure 102 may be effected by standard technique such as eutectic solder bonding, that is illustratively carried out prior to commencing the active alignment process. The bonding of second structure 102 to substrate 101 may also be effect by a solder bonding, illustratively using a lower temperature solder than that used for bonding second optical element 103 to second structure 102. The second structure 102 is illustratively moved in the z-direction to account for any change in the z-position of first structure 104 from its current position to its final bonded position. If solder is used, this differential would be approximately the thickness of the pre-deposited solder used to attach first structure 104 to bulkhead 107. If epoxy is used, there may be essentially no differential given sufficiently rough surfaces on first structure 104 and bulkhead 107.

In accordance with an exemplary embodiment of the present invention, the downward movement (−y-direction) of the second active alignment tool 111 during the bond of second structure 102 to substrate 101 is determined to sub-micron precision using a linear encoder (or similar device) which is an integral part of the motion system for second active alignment tool 111. This motion is used to translate second structure 102 down in the y-direction prior to its being bonded. Other than this y-direction translation and the illustrative z-direction translation described above, the fixturing (i.e., substrate 101 and second active element 111) holding second structure 102 allow substantially no other movement.

Illustratively, after the second structure 102 is aligned, the first structure 104 may be actively aligned using the first active alignment tool 110. This active alignment of the first structure 104 is in the x-y plane and results in the adjustment of the position of the second optical element 106 in this plane. However the first structure 104 is not adjusted in +z-direction, as its motion in this direction is restricted by the bulkhead 107. The first structure 104 may then be adhered to the bulkhead 107 using solder, a laser weld, or epoxy. Both the fixture which holds first structure 104 as well as second structure 102 itself should be designed to allow substantially no movement in the x and y directions during this step. The resulting gap between first structure 104 and second structure 102 may be designed such that a bonding material can be inserted between them in order to provide more mechanical stability. This bonding material may be epoxy, for example.

After the bonding of the first structure 104 to the bulkhead 107 is complete, the optical device 100 may be hermetically sealed via standard technique. If further alignment of a fiber outside of the bulkhead 107 is required, an optical connector 109 containing a fiber and possibly a lens may be actively aligned to the optical device 100, and particularly to the first optical element 106 and the second optical element 103.

It is noted that according to the exemplary optical device 100, the thermal expansion coefficients of various elements should be matched as closely as possible. To this end, it is useful to have the thermal expansion properties of the various elements of the optical device 100 match as closely as possible because thermal mismatch can result in non-uniform movement due to ambient temperature changes in a deployed system. This can lead to misalignment of the first and second optical elements 106 and 103, respectively, and this misalignment can result in poor coupling between the second optical element and an optical waveguide (not shown) to which it is desireably coupled. In the illustrative embodiment shown in FIG. 1, it is useful to have all of the mounting elements made of the same material. To wit, the substrate 101, second structure 102, first structure 104 and bulkhead 107 are illustratively of the same material; or alternatively, of materials which have substantially the same coefficient of thermal expansion. Illustrative materials include monocrystalline and polycrystalline materials such as silicon; ceramic materials; and kovar.

As can be readily appreciated from a review of the illustrative embodiment of FIG. 1, the second structure 102 effects the horizontal alignment of the optical device 100. That is, the movement of the second structure 102 is in the x-z plane, with y-direction (vertical) motion limited by the substrate 101. The first structure 104 is used to carry out the vertical alignment. To this end, the motion of the first structure 104 is in the x-y plane, with the z-direction (horizontal) motion limited by the bulkhead 107. By separating the alignment of the structures in this manner, the potential for “adding” the tolerances of one component to another is mitigated by the present embodiment. To wit, “additive” tolerances, which tend to plague conventional techniques for aligning optical components in optical devices such as subassemblies, are substantially reduced according to the illustrative embodiment of the present invention because two mounting planes that intersect orthogonally (x-z and x-y planes) are used. Quantitatively, as a result of the illustrative method described surrounding the illustrative embodiment of FIG. 1, alignment tolerances of the first optical element 103 to the second optical element 106 and ultimately to an optical waveguide (not shown) are illustratively in the range of approximately ±0.5 μm to approximately ±5 μm. More illustratively, these alignment tolerances may be in the range of approximately less than ±1.0 μm to approximately ±0.5 μm.

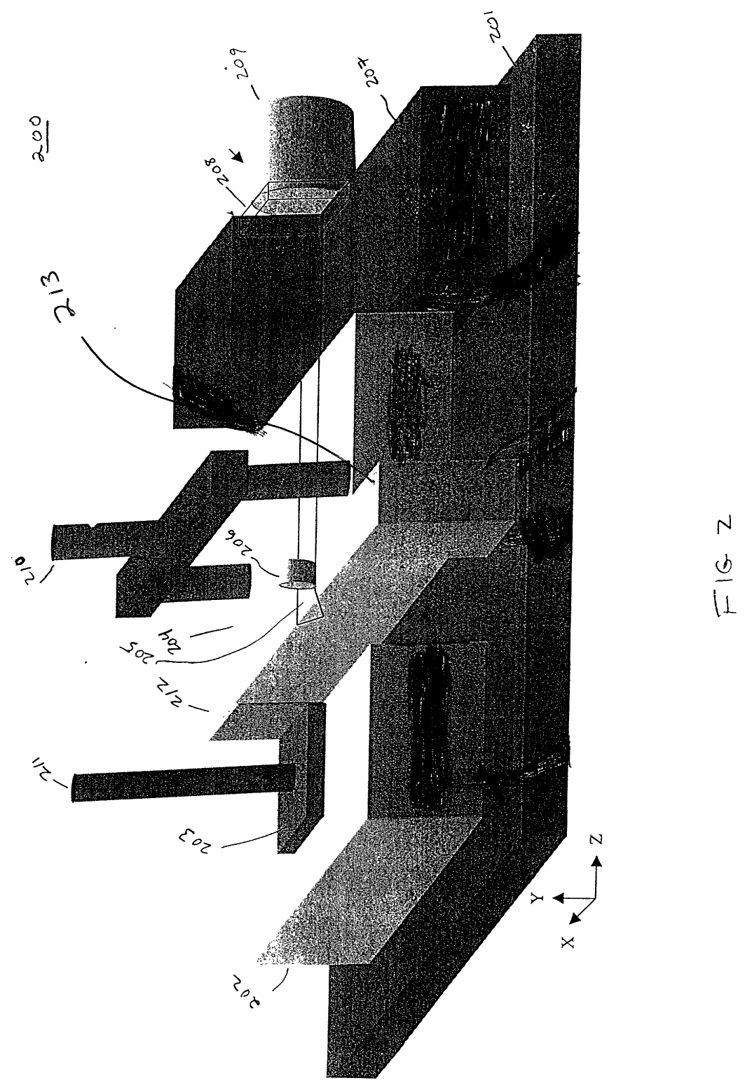

Turning to FIG. 2, an optical device 200 according to another illustrative embodiment is shown. A first structure 204 and a second structure 202 are disposed on a substrate 201. A first optical element 206 is disposed on the first structure 204 and in an alignment feature 205; and a second optical element 203 is disposed on the second structure 202. A bulkhead 207 has a window 208 which enables coupling to a fiber optical fiber connector 209. A first active alignment tool 211 and a second active alignment 210 are used in the alignment process.

The optical device 200 of the illustrative embodiment of FIG. 2 is virtually identical to that of the illustrative embodiment of FIG. 1. To this end, the components, materials and alignment sequence described in the exemplary embodiment of FIG. 1 is substantially the same as the exemplary embodiment of FIG. 2. Accordingly, the similarities therebetween will not be repeated, and only the distinctions will be elaborated upon presently.

As described in connection with the illustrative embodiment of FIG. 1, the first structure 204 is used to effect the vertical alignment (z-direction) between first and second optical elements 206 and 203, respectively, and an optical waveguide (not shown). Accordingly, the first structure 204 may not be bonded directly to the substrate 201. It may be useful, therefore, to incorporate support members 212 and 213, respectively. These support members may be bonded to the first structure 204, either during the active alignment process, or, after the first structure 204 has been bonded to the bulkhead 207.

Typically, the various components which comprise the optical device 200 are fabricated from materials having essentially identical thermal expansions, or Young's moduli. Exemplary materials for such an application include, but are not limited to monocrystalline and polycrystalline materials (e.g. silicon), ceramic materials and kovar. Moreover, while the thermal match of the various components may be useful to assure that standards for ambient temperature variation (illustratively approximately 0 C. to approximately 85 C.) may be met, it may, nonetheless, be useful to include further stability to the structure of the optical device 200. This may be effected by the use of vertical support members 212 and 213, which are bonded to the second structure 204. The vertical bond (y-direction according to the Cartesian coordinate system of FIG. 2) of the first structure 204 to the supports 212 and 213 may further tend to stabilize the optical device 200, particularly when temperature variations in deployed systems occur. Illustratively, vertical support members 212 and 213 may be attached to first structure 204 using opoxy.

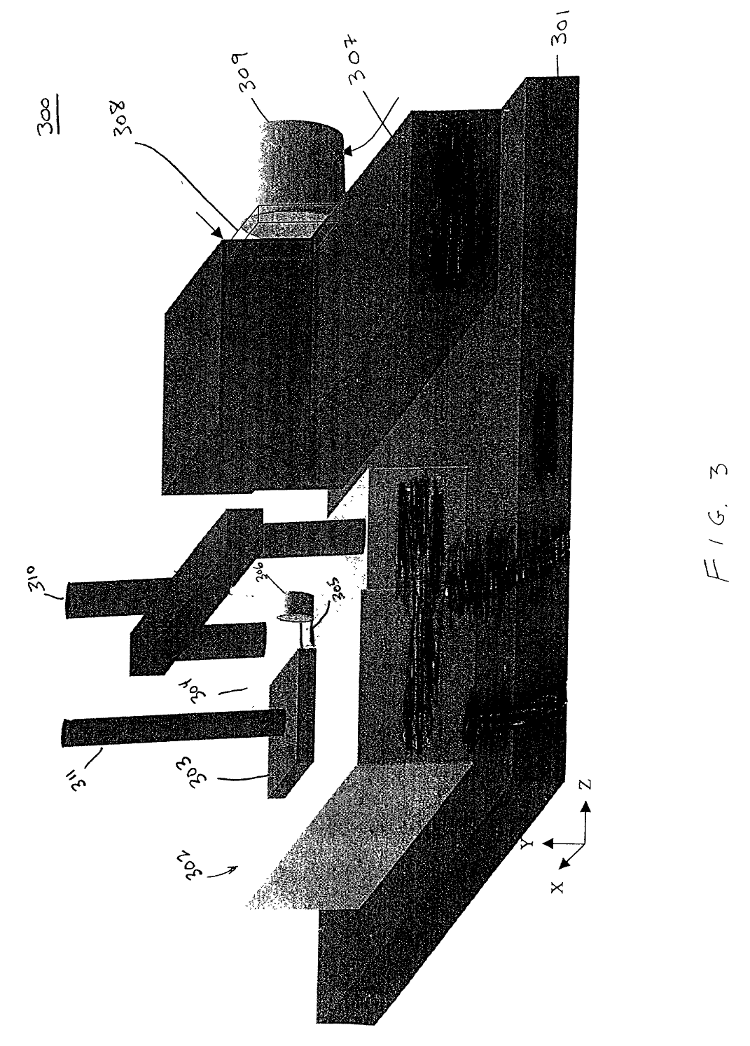

Turning now to FIG. 3, another illustrative embodiment of the present invention is shown. Consistent with the description of the illustrative embodiments of FIGS. 1 and 2, the optical device 300 of the illustrative embodiment of the FIG. 3 incorporates substantially the same elements and materials as described above. Again, the similarities therebetween will not be repeated; and only distinctions therebetween will be described. While the alignment and bonding process described relative to the illustrative embodiment of FIG. 3 is also similar to that of FIG. 1, there are differences worthy of discussion. This variation in alignment and bonding technique associated with the illustrative embodiment of FIG. 3 is described presently.

As discussed above, in assembling the various elements of an optical device such as an optical subassembly, there are alignment tolerances in all three directions. Particularly problematic are the tolerances in the vertical direction (y-axis), also referred to as height tolerances or “stack-up” tolerances. In conventional structures, this results in unadjustable misalignment of optical elements in the optical device 300, and ultimately results in unacceptable performance. In the structure shown in FIG. 3, it is particularly useful to insure that the alignment in the x-y plane (again, according to the Cartesian coordinate system shown) of first optical element 306, second optical element 303, and the optical waveguide (to which the second optical element 303 is ultimately coupled) is effected in a precise manner. To this end, in the example when the second optical element 303 is an emitter, if there is a misalignment in the x-y plane, the angle of incidence of light that is impingent upon the first optical element 306 may be unacceptable. In the illustrative embodiment in which the second optical element 303 is a detector, such as an edge detector, misalignment in the x-y plane can reduce the efficiency of the coupling of light to the detector, as the angle of incidence of light impingent upon the detector may be too great resulting in an unacceptable level of reflection.

The alignment of the various elements of the exemplary embodiment of FIG. 3 is as follows. Initially, elements of the optical device 300 are passively aligned in the z-direction in the present illustrative embodiment. The z tolerance can be minimized by pre-measuring parts and attaching first optical element 306 and/or second optical element 303 before the active alignment. Alignment tolerance in the z-direction is also useful in effecting good device performance. However, a less than optimal alignment in the z-direction (along the optic axis) may be acceptable. Less than optimal z-direction alignment may ultimately result in a reduction in the intensity of the light coupled to the optical waveguide (not shown). This may be acceptable to some degree in certain applications. As such, it may be acceptable to passively align the first optical element 306 and the second optical element 303 in the z-direction. In the illustrative embodiment shown in FIG. 3, the first structure 304 abuts the second structure 302. Accordingly, the alignment between the first optical element 306 and the second optical element 303 in the z-direction is passive. Therefore, the alignment tolerances in the z-direction are limited to the tolerance of the thickness (z-dimension) of the first structure 304 and the second structure 302.

After z-alignment is completed, the alignment in the x-direction may be carried out by active adjustment of the second structure 302 via a second alignment tool 311. Again, this may be a manual adjustment or an automated adjustment.

Once alignment is effected in the x-direction, the second structure 302 may be bonded to the substrate 301. Thereafter, y-registration of the first optical element 306, which is disposed in registration feature 305, may be carried out. Illustratively, the first optical element 306 may be aligned in the y-direction by the adjustment of the first structure 304 using the first active alignment tool 312. Once the proper alignment is effected in the vertical direction (y-axis) the first structure 304 may be bonded to the second structure 302.

The assembly process may be completed by the hermetic sealing of the assembly, and the alignment and bonding of an optical waveguide (not shown). The optical waveguide illustratively is an optical fiber which is inserted into an optical fiber connector 309. It is noted that a fiber may be coupled to optical device 300 without a connector (e.g. in a bonded pigtail fashion). The optical fiber, or other suitable optical waveguide, is an optical communication with the first optical element 306 and the second optical element 303 by way of window 308 in the hermetic package.

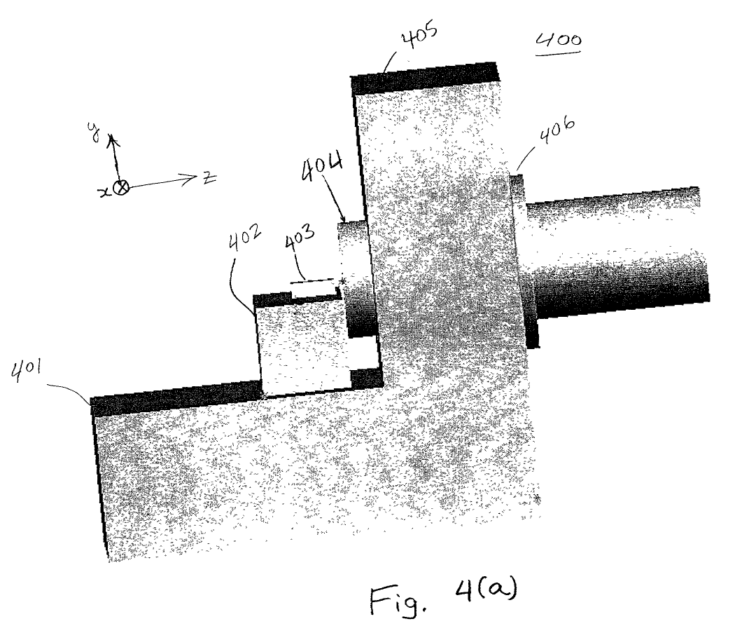

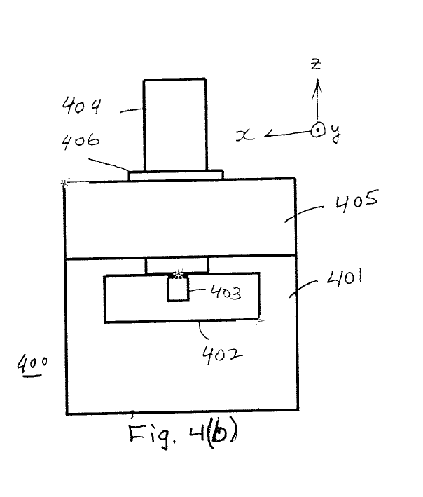

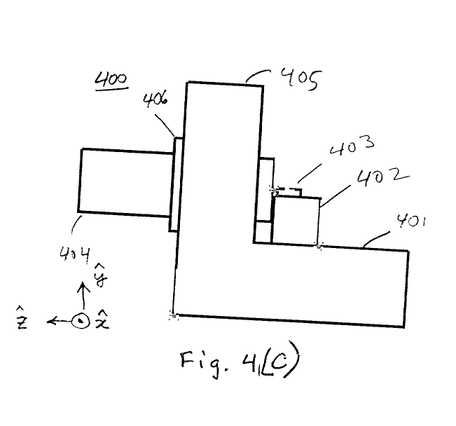

Another illustrative embodiment of the present invention is shown in FIGS. 4(a)-4(c). An optical device 400 includes a substrate 401 having a structure 402 with an optical element 403 disposed thereover. A ferrule 404 protrudes through a bulkhead 405 and is adapted to receive and optical waveguide such as an optical fiber (not shown). A flange 406 is useful in achieving x-y alignment as is described herein. Again, the general features of the optical device 400 are similar to those described in previous embodiments. As such, these similarities will not be repeated, and only the distinctions shall be discussed.

One clear distinction of the present illustrative embodiment is the elimination of the second structure used in the previously described illustrative embodiments of the present invention (e.g. second structure 304 shown in FIG. 3). The structure 402 includes an optical element 403, illustratively an optoelectronic device such as an emitter or detector (previously described). It is noted that ferrule 404 may receive passive optical elements, instead of or in addition to an optical fiber. These passive optical elements include but are not limited to lenses, gratings, and diffractive optical elements such as holographic optical elements.

In the exemplary embodiment shown in FIGS. 4(a)-4(c), alignment is effected according to the present described illustrative technique. Of course, other methods may be used in keeping with the present invention to reduce the stack-up tolerance problems of the prior art. Initially, the structure 402 is aligned. This alignment may be effected in an x-z plane at a random height (y location). As the goal is to align the optical element 403 (again an active device such as a detector or emitter) to an optical waveguide or passive optical elements (not shown) that are illustratively disposed in ferrule 404, it is useful to effect alignment of the structure 402 and optical element 403 via motion in a plane. This planar motion is chosen to be orthogonal to the plane (or direction) of motion of the ferrule 404. Illustratively the flange 406 may be used to achieve planarity in the x-y plane. Once the planarity is set, the flange and ferrule may be directionally moved by an automated device, which maintains the planarity in the x-y plane. After alignment is achieved, the ferrule and flange are moved in the −z direction by the automated device so that the flange abuts the bulkhead. (Of course structure 402 with optical element 403 thereover is moved by a corresponding amount in the −z-direction). Alternatively, the ferrule 404 may be substantially constrained to motion in the x-y plane during the alignment process by the flange 406 that is disposed about an opening (not shown) in the bulkhead 405 through which the ferrule 404 is disposed. After alignment is achieved the flange 406 is bonded to the bulkhead.

Through motion of structure 402 in the x-z plane and motion of the ferrule in the x-y plane, basic alignment of the optical element 403 to the waveguide or other element in the ferrule 404 is achieved. The structure 402 may be bonded to the substrate 401, and the ferrule may be bonded to the flange. It is noted that the structure 402 may be constrained to motion in the x-z plane by other than the substrate (e.g. a controlled automated machine), and after the alignment of the structure 402 to the ferrule 404 via constrained motion of the ferrule 404 and structure 402 in respective orthogonal planes, the structure may be moved in the −y-direction to the substrate to which it is bonded. The ferrule may then be moved in the −y-direction so that the y-coordinates of the optic axes of the optical element 403 and the optical waveguide or other element are the same.

Advantageously, the illustrative embodiment shown in FIGS. 4(a)-4(c) enables the separation of the alignment of various components of the optical device 400. As before, the additive effect of tolerances is substantially reduced according to the illustrative embodiment of the present invention because two mounting planes which intersect orthogonally are used to carry out alignment. In the present illustrative embodiment, the orthogonality of alignment is achieved using the flange 406 about ferrule 404 to achieve x-y alignment; and the motion of the structure 402 in the x-z plane is used to achieve alignment of the optic axes of the respective elements.

As a result of the illustrative alignment methods described in connection with the exemplary embodiments of the present invention, alignment tolerances of the various optical components of the optical elements of the optical devices are illustratively in the range of approximately ±0.5 μm to approximately ±5 μm. More illustratively, these alignment tolerances may be in the range of approximately less than ±1.0 μm to approximately ±0.5 μm.

The invention having been described in detail, it will be readily apparent to one having ordinary skill in the art that the invention may be varied in a variety of ways. Such variations are not to be regarded as a departure from the scope of the invention. All such modifications as would be obvious to one of ordinary skill in the art, having had the benefit of the present disclosure, are intended to be included within the scope of the appended claims and the legal equivalents thereof.

I claim:

1. A method of fabricating an optical device, the method comprising:
a.) disposing a first optical element on a first structure;
b.) disposing a second optical element on a second structure;
c.) moving said first structure in a first plane to effect a first alignment; and
d.) moving said second structure in a second plane, which is orthogonal to said first plane to effect a second alignment, wherein said first optical element and said second optical element are optically coupled after said second alignment.

2. A method as recited in claim 1, wherein said first structure is disposed on a substrate.

3. A method as recited in claim 1, wherein said second structure is disposed over a substrate.

4. A method as recited in claim 1, wherein said first optical element is an active optical device.

5. A method as recited in claim 1, wherein said second optical element is a passive optical element.

6. A method as recited in claim 1, wherein said moving of said first and said second structures is automated.

7. A method as recited in claim 1, wherein said first optical element and said second optical element are aligned with a tolerance in the range of approximately ±0.5 μm to approximately ±5 μm.

8. A method of fabricating an optical device, the method comprising:
(a) moving a first optical element in a first plane;
(b) moving a second optical element in a second plane which is orthogonal to said first plane; and
(c) aligning said first optical element to said second optical element.

9. A method as recited in claim 8, wherein said first optical element is disposed on a first structure.

10. A method as recited in claim 8, wherein said second optical element is disposed on a second structure.

11. A method as recited in claim 8, wherein said second optical element is disposed in a ferrule.

12. A method as recited in claim 8, wherein said second optical element is a passive optical element.

13. A method as recited in claim 8, wherein said moving of said first and said second structures is automated.

14. A method as recited in claim 11, wherein said ferrule is disposed in an opening in a bulkhead or a flange is disposed about said opening.

15. A method as recite din claim 8, wherein said first optical element and said second optical element are aligned with a tolerance in the range of approximately ±0.5 μm to approximately ±5 μm.

16. An optical device, comprising:
a first optical element disposed over a structure; and
a second optical element, wherein said first optical element and said second optical element are aligned with a tolerance in the range of approximately ±0.5 μm to approximately ±5 μm.

17. An optical device as recited in claim 16, wherein said range is approximately less than ±1.0 μm to approximately ±0.5 μm.

18. An optical device as recited in claim 16, wherein said second optical element is disposed over another structure.

19. An optical device as recited in claim 16, wherein said second optical element is disposed in a ferrule.

20. An optical device as recited in claim 19, wherein said ferrule is disposed in an opening in a bulkhead and a flange is disposed about said opening.

21. An optical device as recited in claim 16, wherein said second optical element is a passive optical element.
